(19) United States
(12) Patent Application Publication
(10) Pub. No.: US 2004/0150815 A1
(43) Pub. Date: Aug. 5, 2004

(54) Flaw detection in objects and surfaces

(75) Inventors: Richard Allen Sones, Cleveland Heights, OH (US); Amir Reza Novini, Akron, OH (US)

Correspondence Address: BUCKINGHAM, DOOLITTLE & BURROUGHS, LLP, 50 S. MAIN STREET, AKRON, OH, 44308, US

(73) Assignee: Applied Vision Company, LLC, Akron, OH (US)

(21) Appl. No.: 10/359,117

(22) Filed: Feb. 5, 2003

(51) Int. Cl. G01N 21/00

(52) U.S. Cl. 356/239.4

(57) ABSTRACT

The invention relates generally to the simultaneous acquisition of superimposed color dark-field and light-field images with a camera followed by decoupling of the images into monochrome components for further analysis of surface defects.

### TECHNICAL FIELD

The invention relates to the rapid inspection of surfaces, particularly sealing surfaces and involves the simultaneous acquisition of superimposed color dark-field and light-field images with a single camera.

### BACKGROUND OF THE INVENTION

An ideal glass container has a smooth and flat sealing surface against which the container closure makes a tight seal. Sealing-surface defects such as cracks, scratches, roughness, chips, and other disconformities in the surface may lead to improper seating of the closure, and can prevent hermetic sealing of the container. This in turn leads to spoilage of the container contents. Accordingly, it is necessary to detect such defects on the mouths of these bottles to prevent use of bottles with defects.

Machine vision technology is widely used to inspect the sealing surfaces of glass containers as they are being manufactured or for reuse, to automatically reject defective containers. The inspection of the sealing surface by means of machine vision requires suitable illumination of the sealing surface, and the characteristics of the illumination should allow confident inspection without generating spurious reflections from other portions of the container or its surroundings. Different containers require different illumination techniques for optimum visibility of defects. Two well-known illumination strategies used in sealing-surface inspection are “light-field” and “dark-field” illumination. With light-field illumination, the lighting geometry is designed so that the inspected surface is visible in the camera image, and defects appear as light or dark structures on this surface against an otherwise uniform gray background. With dark-field illumination, the lighting geometry is designed so the inspected surface is entirely dark (not visible), and flaws appear as bright glints against the dark background. Typically, light field illumination is better at finding certain types of defects, and dark field illumination is better at finding other types of defects. In many applications it is desirable to simultaneously and sequentially use both light field and dark field inspections.

Although various methods of detecting defects on a bottle mouth have been proposed, such methods have not provided optimum illumination of the sealing surface. As the defects which may be present and the character of the defects can vary greatly, the illumination of the surface should facilitate identification of any such defects, and yet prior systems have not adequately provided this ability. To detect the widely differing types of defects, it would be desirable to provide illumination which is directed at the surface from differing angles to facilitate defect identification. Further, no such methods are adaptable to different container configurations in a simple and effective manner. It would also be desirable to provide an illumination system and characteristics which allow adaptability to different container configurations and sealing surface characteristics. Other prior art inspection methods and systems have required a container to be rotated 360 degrees under one or more light beams to fully illuminate the sealing surface, but such physical manipulation causes difficulties, as the system is more mechanically complex, and requires an extended dwell time for inspection, which adversely impacts on production in the manufacturing process. It would therefore also be desirable to provide a system and method which allows for inspection without physical manipulation of the container, and at very high production speeds.

High speed Inspection of a sealing surface of a glass container (e.g., bottle, jar, vial, etc.) typically involves rapid movement of the container along a conveyor. The finish of a glass container is the upper portion near the cap or like, sometimes containing screw threads. The sealing surface is the upper surface of the finish, usually flat, which makes a seal against the cap or lid. The current state of the art is to image the sealing surface with a monochrome camera and a monochrome light source positioned above the container. The light source is typically strobed (pulse duration on the order of one hundred to several hundred microseconds, this time duration being known to those of skill in the art) in order to prevent motion blur. Image acquisition is synchronized with the light source strobe pulse, and both are triggered by a part-present sensor (typically a through beam photosensor) which detects when the container is directly underneath the camera.

Due to inevitable variations in container centering on the conveyor, container shape, part-present sensor noise, etc., the position of the sealing surface in the image varies slightly. So-called “registration” algorithms (which search the image for the outer or inner edges of the sealing surface) are used to locate the sealing surface within the image and guide a donut-shaped region of interest into position coincident with the sealing surface. Then flaw detection algorithms are run on the donut-shaped region.

However, with dark-field illumination, the edges of the sealing surface are not reliably visible in the image, so it is impossible to perform robust registration of the donut-shaped region. Imprecise registration leads to false rejects, since features of the container just inside or outside the sealing surface (such as threads for screwing on a container lid) may strongly reflect the dark-field illumination and be misinterpreted as defects. Light-field illumination however, identifies sealing surfaces as a bright donut, and it is easy to register on the sealing surface. For flaw detection, however, the flaws must cover several pixels to be detected.

Therefore, what has been lacking in the industry is a system which combines the registration and flaw detection capabilities using light-field illumination, with the flaw detection capabilities using dark-field illumination without the need for two detection devices. The invention resolves this issue by simultaneously capturing one color image with a single camera wherein dual illuminators are used, a first illuminator for registration and light-field illumination and a second illuminator for dark-field illumination. The system of the instant invention capitalizes on the best elements of both detection systems. This is an advantage provided by the present invention.

### SUMMARY OF THE INVENTION

The invention is directed to a single color camera image acquisition system using dual illuminators. A green image is used for registration and light-field illumination coupled with sealing surface inspection while a red image is used for dark-field illumination coupled with sealing surface inspection.

The simultaneously obtained color image is recorded on a single camera in which the green and red images perfectly superimpose upon each other in that the green image is used for registration of the red image.

These and other objects of the present invention will become more readily apparent from a reading of the following detailed description taken in conjunction with the accompanying drawings wherein like reference numerals indicate similar parts, and with further reference to the appended claims.

### BRIEF DESCRIPTION OF THE DRAWINGS

The invention may take physical form in certain parts and arrangements of parts, a preferred embodiment of which will be described in detail in the specification and illustrated in the accompanying drawings which form a part hereof, and wherein:

FIG. 1 is a schematic illustration of a machine vision system and container inspection according to the invention;

FIG. 2 is a side elevational view of the light-field dome illuminator; and

FIG. 3 is a cross-sectional view of the dark-field ring illuminator taken along line 3-3;

FIG. 4 is a color image illustrating a sealing surface flaw;

FIG. 5 is a light-field illumination green image after processing the image of FIG. 4; and

FIG. 6 is a dark-field illumination red image after processing the image of FIG. 4.

### DETAILED DESCRIPTION OF THE INVENTION

Referring now to the drawings wherein the showings are for purposes of illustrating the preferred embodiment of the invention only and not for purposes of limiting the same, the figures show a machine vision defect detection system which detects a variety of surface flaws. Illumination is one of the most important issues in machine vision. Most imaging systems usually include an optical system, illumination system, camera sensor and data analyzing system. Any of these systems can be a bottleneck in the imaging process. The best diffraction limited optical system will not supply good image quality without the correct illumination. The illumination system can either enhance or diminish some features of a monitored object. Furthermore, poor illumination can even create artifacts.

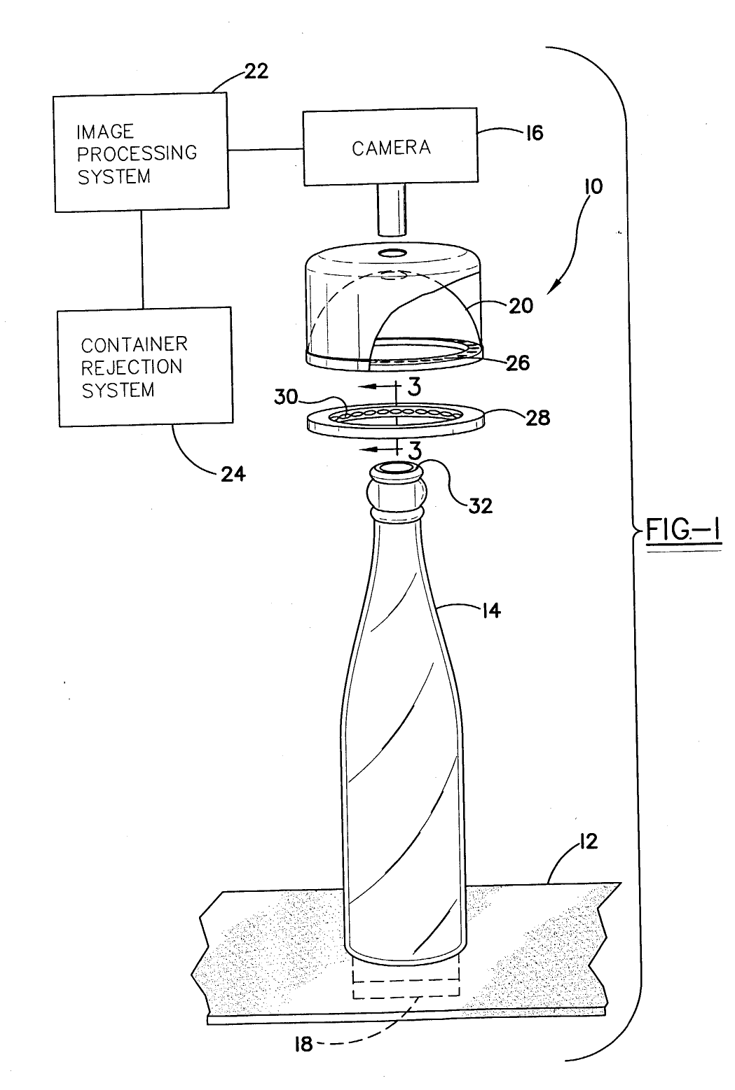

Specifically, FIG. 1 shows a dual illumination system for the detection of flaws which reside on the sealing surface of an object to be evaluated. The machine vision system 10 includes a light-field hemispherical dome illuminator 20 and a dark-field ring illuminator 28, the light rays of which are directed upon the sealing surface 32 of a glass container 14 positioned upon a moving conveyor system 12. For inspection of the sealing surface 32 of container 14, the illumination systems are positioned above and in alignment with the centers of the containers which pass directly underneath the center of the illumination systems. A camera 16 is mounted above the light-field illuminator 20 and provides an image forming system to generate a color image of the sealing surface 32. As containers 14 are moved past the machine vision system 10, a photoelectric part-present sensor 18 or other suitable mechanism is typically used to trigger operation of the illumination systems in a strobed fashion, and a color image is acquired of the sealing surface 32. An image processing system 22 is used to analyze the image and determine if defects exist in the sealing surface 32, and if the system detects the presence of a defect, a container rejection system 24 may also be used to remove the defective container from the conveyor 12. It is recognized by those of skill in the art, that the machine vision system 10 may also be used to inspect objects other than containers 14, or may be used in other ways other than for inspection.

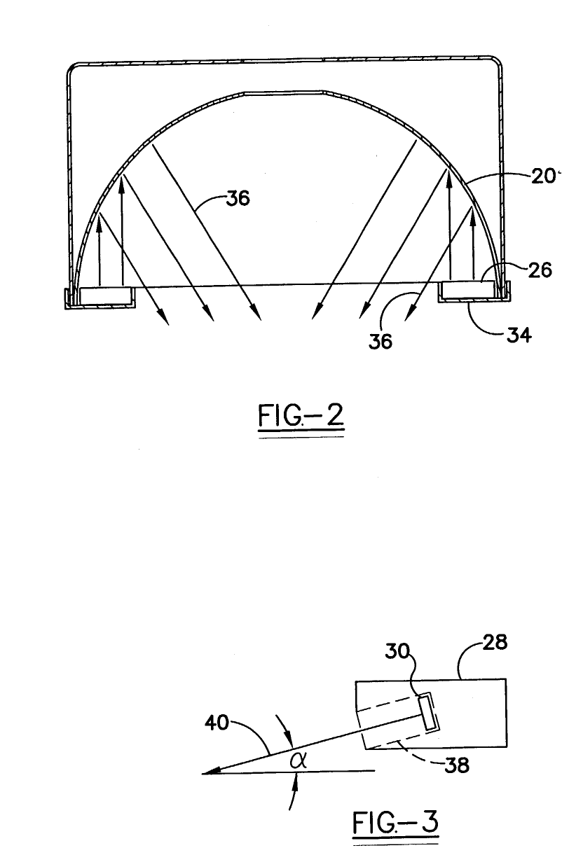

Referring now to FIG. 2, the light-field hemispherical bowl illuminator 20 includes a generally circular array of upwardly pointing LED's 26 mounted at a bottom portion of the housing 34 of the illuminator. The dome illuminator provides diffused, strobed uniform light 36 through reflection off the high reflective coating on the inner side of the dome. The LED array is strobed briefly (to freeze motion) each time a container 14 is directly underneath the illuminator and in colinear z-axis alignment with the camera 16. In one embodiment of the invention, the LEDs are green, although it is recognized that other LED colors are possible to use in this invention, e.g., infrared, red, orange, yellow, green, blue and ultraviolet, etc. The LED array can be a single circular or a multi-row array about the periphery of the bottom housing 34 or positioned at various positions throughout the dome itself, depending on the degree of illumination required. While a dome illuminator has been indicated to be a preferred embodiment, other illumination techniques are also applicable, e.g., “cloudy day illuminator” or a diffuse on-axis light, whereby light arrays reflect off the beam splitter directly on to the object at nearly 90°, and where specular surfaces perpendicular to the camera appear illuminated while surfaces at an angle to the camera appear dark. It is also possible to use collimated on-axis light which provides collimated illumination in the same optical path as the camera.

Referring now to FIG. 3, the dark-field ring illuminator 28 produces low-angle directional illumination to the region of interest which includes sealing surfaces, web surfaces, wafer surfaces, as well as other targeted areas, using either a single tier or multi-row tiers of LEDs mounted into a housing. This ring illuminator provides directional, strobed uniform light 40, strobed essentially simultaneously with the light field illuminator 20. In one embodiment of the invention, the LED is red, although it is recognized that other LED colors are possible, as illustrated in the previous paragraph. The light is typically directed at an angle alpha (α) (low angle) which is approximately 5-30°, preferably 8-22°, more preferably, 10-18°, most preferably 14.4°.

While a red and green LED color combination is illustrated above, there is no need to limit the invention to such, and in fact, other color combinations, such as red and blue, and green blue combinations are applicable. In fact, other color combinations, such as yellow and blue or orange and blue, orange and green, etc., are applicable. One factor in deciding which color combinations work best is the degree of separation in the wavelength of the colored light combinations so that there is minimal crosstalk from one color to the other compatible with standard color cameras. For example, the peak wavelength for a red LED is approximately 660 nm, while the peak wavelength for an orange LED is about 620 nm. The proximity of these peak wavelengths means that there is a degree of overlap or crosstalk between the colors. However, yellow LED light has a peak wavelength of about 590 nm. A combination of red and yellow LEDs would be favored over a combination of red and orange LEDs due to the higher degree of separation between the bands. Green LEDs have a peak wavelength of about 525 nm while blue LEDs have a peak wavelength around 470 nm. While blue and green combinations are less favored, these colors matched with red or orange are more desirable. However, it should be noted that wavelength separation is but one factor in the choice of colors, and other factors are also applicable. Wavelength separation by itself would suggest that a red and blue LED combination would be the most preferred embodiment, whereas experiments have shown to date that a red and green LED color combination is more preferred. This invention is additionally not limited to LED illumination, and can be used with colored light of any sort, including lasers, fluorescent and incandescent to mention a few.

One of the most popular patterns for the color filter arrays (CFAs) used in image sensors is the three-color checkerboard pattern invented by Dr. Bryce E. Bayer who suggested that either of two color schemes could be employed for capturing multi-color information with a camera's sensor: RGB (Red-Green-Blue) or CMY (Cyan-Magenta-Yellow), although the RGB color filter array is more prevalent in many digital cameras. Either color filter array will function in this invention. Until recently, only the RGB pattern has been employed due to issues with color fidelity and sensor manufacturing, although the CMY pattern may have certain advantages, primarily in the area of quantum efficiency, spectral response and sensitivity. In photographic terms, this sensitivity may result in superior performance across a wide range of light exposures (ISO Ratings).

The photoactive area of an image sensor is made up of pixels (picture elements), which are regions that convert light to electrical charge. This charge is proportional to the amount of light striking the pixel. During sensor readout, the charge is converted into a proportional voltage signal, which is subsequently sampled by an analog-to-digital converter. When a camera shutter takes a picture, each pixel is presented with an amount of light that originated in the scene being photographed. Each color in the scene is made up of different amounts of energy at particular wavelengths of light. When a pixel has a color filter placed above it, it responds more strongly to the wavelength of that particular color. The signal developed at the pixel, though, represents an integration of all the wavelengths of light striking the pixel. For example, the green pixels in a sensor with an RGB color filter array pattern responds more to green scene content, but the total green signal integrates all the energies in the entire 400 to 700 nm wavelength band.

One additional extension of the above technique is to use three different color illuminators (red, green and blue or a cyan, magenta and yellow) with a single color camera, in order to obtain three essentially independent “monochrome” images (instead of just two). The three illuminators could all be configured with dark-field geometry, and adjusted to shine at different angles on the container finish. A given illuminator would be optimized for one type (location and orientation) of check, and the check-detection algorithms applied to the corresponding image would also be optimized for that type of check. Alternatively, one could configure two of the illuminators with dark-field geometry and the remaining illuminator with light-field geometry, so the light-field image could serve to register the dark-field inspections.

While a three channel camera has been described above, there is no need to limit the invention to such, and in fact when a multi-spectral (or multi-channel) imaging camera is used, the number of applicable colors is limited only by the number of channels in the camera. For example, Olympus Optical Co., Ltd., has recently announced that it has a camera that captures images in 16 primary colors (with 16 simply being an arbitrary figure) by dividing the color spectrum into 16 wavelengths utilizing 16 band paths filters with differing transmission characteristics, providing superior color reproduction and superfine resolution thereby removing the typical limitation of the three primary colors of either red, green and blue, or cyan, magenta and yellow.

In operation, the LED lights (green and red) are energized essentially simultaneously, once the photoelectric part-present detection is made and collinear alignment is achieved with the camera and one composite image is acquired, comprising both red and green components which are then separated. One of the keys to the invention is the ability to discriminate between the dark-field and light-field images by using two different color illuminators. The dark-field and light-field images are acquired substantially simultaneously and superimposed with a color camera. Through the use of “software filtering”, the two color components (dark-field and light-field) are separated into two monochrome images which are in perfect registration. In order to perform both dark-field and light-field inspections, prior art techniques require two sequential image acquisitions. Even if these two images are obtained in rapid sequence with a single camera, the part motion makes it impossible to use registration from the light-field image with the dark-field image.

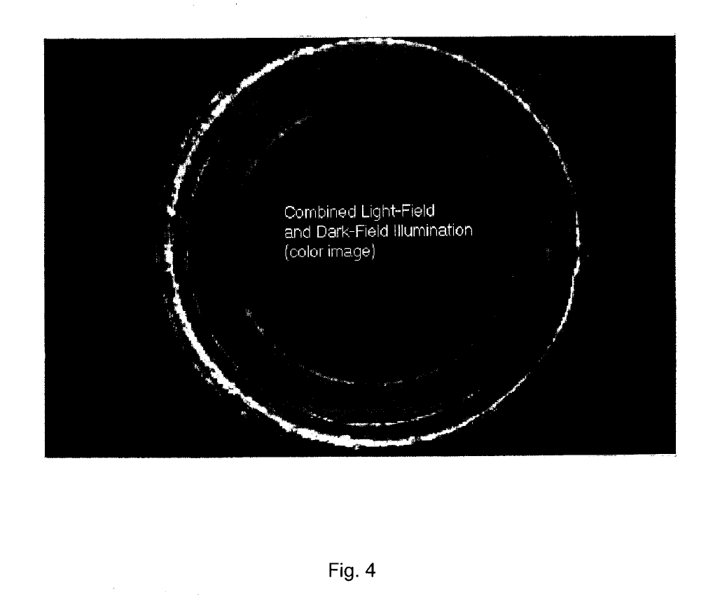

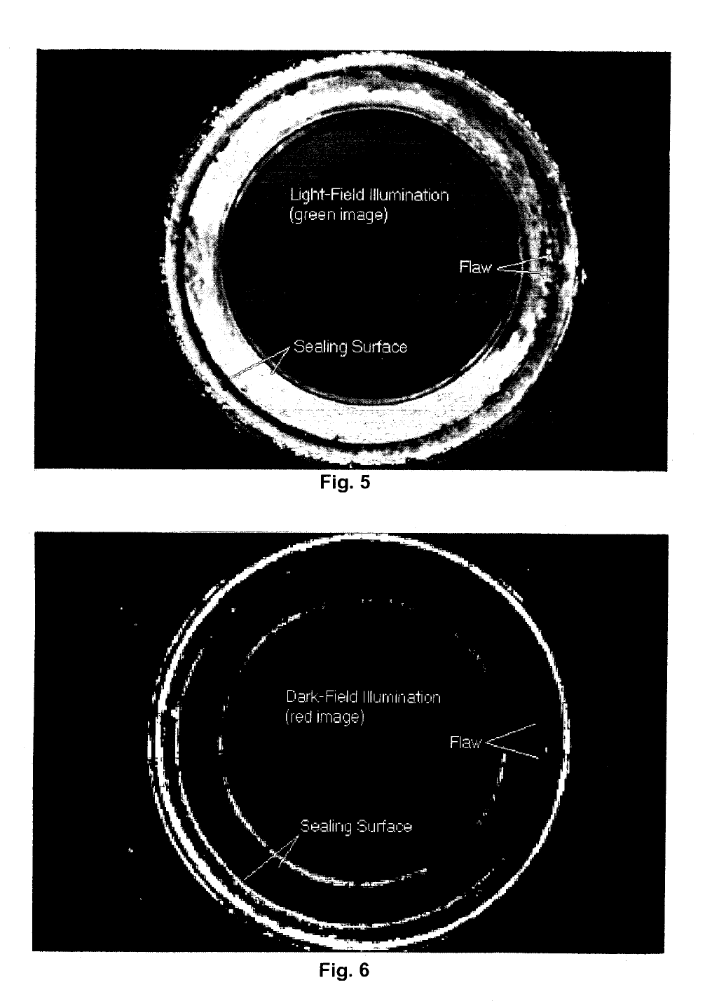

In the attached images, there are three basic images: the combined (red+green) image (color) (FIG. 4); the extracted green component (monochrome) (FIG. 5); and the extracted red component (monochrome) (FIG. 6). Even-though a flaw is visible in both the red and green images, the “rough” nature of the good part of the sealing surface in the green image makes it very difficult to reliably detect the defect in this image. The red image, on the other hand, is quite “smooth” everywhere except over the flaw. This is what makes the red (dark-field) image so useful. A color image as defined in this application, consists of three “monochrome” images, one acquired with a red filter, one with a green filter, and one with a blue filter. Each pixel in a color image has three components: red, green and blue. It is possible to display just one of any of the three components by extraction of the appropriate component of each color pixel.

Yet another one of the keys to the invention is the use of both light-field and dark-field illumination simultaneously. Light-field illumination and dark-field illumination each have significant advantages and disadvantages in the detection of imperfections on sealing surfaces as illustrated in the following table.

TABLE I

| | Light-Field | Dark-Field |
|---|---|---|
| Lineover | Good | Good |
| Crizzled finish | Good | Good |
| Split finish | Good | Good |
| Overpress | Good | Poor |
| Check | Poor | Good |
| Dust tolerance | Good | Poor |
| Registration | Easy | Difficult |
| Resolution | Several pixels | Sub-pixel |

For example, a check defect is a crack or split which is often completely within the glass, and glass manufacturers are particularly concerned about checks which occur in the finish. Typically, checks are due to a problem in the glass molding process and tend to recur in the same location and orientation on some fraction of the containers produced. Dark-field illumination is used for the check inspection. Current state-of-the-art check detectors do not use machine vision. Instead, they employ multiple (typically 5 to 10) light sources and multiple (typically 5 to 10) photosensors arrayed above and surrounding the container finish, and the container is rapidly rotated about its symmetry axis during inspection. Check defects tend to scatter light incident on the container finish back to the photosensors, while non-flawed containers do not scatter light. This is a form of dark-field illumination. Trained personnel carefully set up the light sources and photosensors at appropriate angles to detect the types of checks which are known to occur on the container being manufactured. Because the containers must be stopped, gripped and spun, current check inspection is relatively slow and risks damaging containers. Furthermore, manual setup of the lights and photosensors requires considerable skill and is time-consuming. Hence, there is a strong desire to replace the current state of the art with some form of machine vision, where the containers could simply be imaged while they move along a conveyor, and the setup could be (at least partially) automated.

This invention has been described in detail with reference to specific embodiments thereof, including the respective best modes for carrying out each embodiment. It shall be understood that these illustrations are by way of example and not by way of limitation. Accordingly, the scope and content of the present invention are to be defined only by the terms of the appended claims.

What is claimed is:

1. A machine vision inspection method comprising the steps of:
(a) illuminating an area to be inspected with a first illuminator by emitting light of a first color, said first illuminator providing light-field illumination of said area;
(b) illuminating said area with a second illuminator emitting light of a second color, said second illuminator providing dark-field illumination of said area, said first and second color light being of different bands of wavelengths;
(c) acquiring a color image of said area while said area is illuminated with both said first and said second illuminators;
(d) processing data within said color image to detect flaws in said area.

2. The method of claim 1 further comprising the steps of:
(a) generating a first monochrome image from said color image, said first monochrome image corresponding to the brightness of said first color within said color image;
(b) generating a second monochrome image from said color image, said second monochrome image corresponding to the brightness of said second color within said color image;
(c) processing data within said first monochrome image and said second monochrome image to detect flaws in said area.

3. The method of claim 2 further comprising the steps of:
(a) processing data within said first monochrome image in order to determine the position of said area within said first monochrome image;
(b) using said position to guide further processing of data within said first monochrome image to detect flaws in said area.

4. The method of claim 3 which further comprises the step of:
(a) using said position to guide further processing of data within said second monochrome image to detect flaws in said area.

5. The method of claim 4 which further comprises the step of:
(a) using said position to guide further processing of data within both said first monochrome image and said second monochrome image.

6. The method of claim 3 wherein
(a) said steps of illuminating occur substantially simultaneously.

7. The method of claim 6 wherein
(a) said steps of illuminating are strobed in association with a detection of said area to be inspected by an area-present sensor.

8. The method of claim 7 wherein
(a) said area-present sensor is a photoelectric cell.

9. The method of claim 1 wherein
(a) said step of processing data comprises using a color filter array selected from the group consisting of red, green, blue and cyan, magenta, yellow.

10. The method of claim 1 wherein
(a) said step of processing data comprises using a multi-spectral array.

11. A machine vision inspection method comprising the steps of:
(a) illuminating an area to be inspected with a first illuminator by emitting light of at least a first color, said first illuminator providing light-field illumination of said area;
(b) illuminating said area with a second illuminator emitting light of at least a second color, said second illuminator providing dark-field illumination of said area, said first and second color light being of different bands of wavelengths;
(c) acquiring a color image of said area while said area is illuminated with both said first and said second illuminators;
(d) processing data within said color image to detect flaws in said area.

12. The method of claim 11 further comprising the steps of:
(a) generating a first monochrome image from said color image, said first monochrome image corresponding to the brightness of said first color within said color image;
(b) generating a second monochrome image from said color image, said second monochrome image corresponding to the brightness of said second color within said color image;
(c) processing data within said first monochrome image and said second monochrome image to detect flaws in said area.

13. The method of claim 12 further comprising the steps of:
(a) processing data within said first monochrome image in order to determine the position of said area within said first monochrome image;
(b) using said position to guide further processing of data within said first monochrome image to detect flaws in said area.

14. The method of claim 13 which further comprises the step of:
(a) using said position to guide further processing of data within said second monochrome image to detect flaws in said area.

15. The method of claim 14 which further comprises the step of:
(a) using said position to guide further processing of data within both said first monochrome image and said second monochrome image.

16. The method of claim 13 wherein
(a) said steps of illuminating occur substantially simultaneously.

17. The method of claim 16 wherein
(a) said steps of illuminating are strobed in association with a detection of an area to be inspected by an area-present sensor.

18. The method of claim 17 wherein
(a) said area-present sensor is a photoelectric cell.

19. The method of claim 11 wherein
(a) said step of processing data comprises using a color filter array selected from the group consisting of red, green, blue and cyan, magenta, yellow.

20. The method of claim 11 wherein
(a) said step of processing data comprises using a multi-spectral array.

21. A machine vision inspection method comprising the steps of:
(a) illuminating an area to be inspected with a first and second illuminator, said illuminators emitting a first and second color light of different bands of wavelengths;
(b) acquiring a color image of said area while said area is illuminated with both said first and said second illuminators;
(c) processing data within said color image to detect flaws in said area.

22. The method of claim 21 further comprising the steps of:
(a) generating a first monochrome image from said color image, said first monochrome image corresponding to the brightness of said first color within said color image;
(b) generating a second monochrome image from said color image, said second monochrome image corresponding to the brightness of said second color within said color image;
(c) processing data within said first monochrome image and said second monochrome image to detect flaws in said area.

23. The method of claim 22 further comprising the steps of:
(a) processing data within said first monochrome image in order to determine the position of said area within said first monochrome image;
(b) using said position to guide further processing of data within said first monochrome image, such further processing designed to detect flaws in said area.

24. The method of claim 23 which further comprises the step of:
(a) using said position to guide further processing of data within said second monochrome image to detect flaws in said area.

25. The method of claim 24 which further comprises the step of:
(a) using said position to guide further processing of data within both said first monochrome image and said second monochrome image.

26. The method of claim 23 wherein
(a) said steps of illuminating occur substantially simultaneously.

27. The method of claim 26 wherein
(a) said steps of illuminating are strobed in association with a detection of an area to be inspected by an area-present sensor.

28. The method of claim 27 wherein
(a) said part-present sensor is a photoelectric cell.

29. The method of claim 21 wherein
(a) said step of processing data comprises using a color filter array selected from the group consisting of red, green, blue and cyan, magenta, yellow.

30. The method of claim 21 wherein
(a) said step of processing data comprises using a multi-spectral array.

31. A machine vision inspection method comprising the steps of
(a) illuminating an area to be inspected with at least three means for emitting light, each means of different bands of wavelengths;
(b) acquiring a color image of said area while said area is illuminated;
(c) processing data within said color image to detect flaws in said area.

32. The method of claim 31 further comprising the steps of:
(a) generating three monochrome images from said color image, each of said monochrome images corresponding to the brightness of said different bands of wavelengths within said color image;
(b) processing data within said monochrome images to detect flaws in said area.

33. The method of claim 32 wherein
(a) said step of illuminating further comprises at least one illuminator being configured to provide light-field illumination of said area.

34. The method of claim 33 wherein
(a) said step of illuminating further comprises at least one illuminator being configured to provide dark-field illumination of said area.

35. The method of claim 32 further comprising the steps of:
(a) processing data within said first monochrome image obtained from said at least one illuminator configured to provide light-field illumination in order to determine the position of said area within said first monochrome image;
(b) using said position to guide further processing of data within said first monochrome image, such further processing designed to detect flaws in said area.

36. The method of claim 35 which further comprises the step of:
(a) using said position to guide further processing of data within said second and third monochrome images to detect flaws.

37. The method of claim 36 wherein
(a) said steps of illuminating occur substantially simultaneously.

38. The method of claim 37 wherein
(a) said steps of illuminating are strobed in association with a detection of an area to be inspected by an area-present sensor.

39. The method of claim 38 wherein
(a) said area-present sensor is a photoelectric cell.

40. The method of claim 31 wherein
(a) said step of processing data comprises using a color filter array selected from the group consisting of red, green, blue and cyan, magenta, yellow.

41. The method of claim 40 wherein
(a) said step of processing data comprises using a multi-spectral array.

42. An apparatus which comprises:
(a) a first means for emitting light of a first color to provide light-field illumination of an area;
(b) a second means for emitting light of a second color to provide dark-field illumination of said area, said first and second color light being of different bands of wavelengths;
(c) a means for area-present detection which strobes said means for predetermined intervals;
(d) a color image acquisition means for acquiring a color image of said area while said area is simultaneously illuminated;
(e) a processing means for processing data within said color image to detect flaws in said area.

43. The apparatus of claim 42 wherein
(a) said second means for emitting light is low angle directional light.

44. The apparatus of claim 43 wherein
(a) said low angle is between approximately 5 to 30°.

45. The apparatus of claim 44 wherein
(a) said angle is between approximately 8-22°.

46. The apparatus of claim 45 wherein
(a) said angle is between approximately 10-18°.

47. The apparatus of claim 42 wherein
(a) said means for emitting light are LEDs.

48. The apparatus of claim 47 wherein
(a) Said LEDs are selected from the group consisting of infrared, red, orange, yellow, green, blue and ultraviolet LEDs.

49. The apparatus of claim 48 wherein
(a) said first means for emitting light is a green LED, and
(b) said second means for emitting light is a red LED.

50. The apparatus of claim 42 wherein
(a) said area-present means is a photoelectric cell.

51. The apparatus of claim 50 wherein
(a) said first illuminator is selected from the group consisting of hemispherical dome illuminators, cloudy day illuminators and on-axis light illuminators.

52. The apparatus of claim 51 wherein
(a) said second illuminator is a ring illuminator.
